(19) United States
(12) Patent Application Publication
(10) Pub. No.: US 2004/0006631 A1
(43) Pub. Date: Jan. 8, 2004

(54) Management of access to equipment of the like using a logic key

(76) Inventors: Hisanori Nonaka, Tokaimura (JP); Shigetoshi Sakimura, Hitachi (JP); Yasuo Satou, Hitachi (JP); Kenji Araki, Mito (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/610,703

(22) Filed: Jul. 2, 2003

(30) Foreign Application Priority Data
Jul. 2, 2002 (JP) 2002-192990

(51) Int. Cl. G06F 15/16

(52) U.S. Cl. 709/229

(57) ABSTRACT

Access managing apparatus, maintenance operation-assisting access managing apparatus, access management object apparatus, maintenance operation access management object apparatus, and methods therefor. The apparatus and methods reduce the burden on managers, administrators, operators, or monitoring center personnel regarding management of access to facilities, installations, or equipment. Access management operations include the entry into a facility, installation or equipment for operations, the acquisition of control right, and the issuance of a password for an operation database. When requesting an operation, logic keys are extracted in advance that provide the right of access to the facility, installation or equipment requiring a series of operation to be implemented by the operator. The logic keys or their temporary versions are transmitted to the operator.

### BACKGROUND OF THE INVENTION

1. Technical Field

The present invention relates to the management of access to a facility, an installation, or equipment for entry and operation by establishing an access right. Specifically, the invention relates to an access management apparatus, a maintenance operation-assisting access management apparatus, an access management object apparatus, a maintenance access management object apparatus, methods of such management, a maintenance operation bidding method, and programs therefor.

2. Background Art

In the management of large-sized systems such as buildings, elevators, manufacturing equipment in factories, plant equipment, power or railroad facilities, the task of monitoring such facilities, installations or equipment and that of actually entering the premise and operating the relevant machinery are assigned to different persons. Typically, a monitor worker at a monitoring center continuously monitors information gathered by various on-site devices or sensors and transmitted via a communication network to the center. If a trouble occurs, he or she dispatches an appropriate worker (“operator”) to the site for taking care of the trouble.

When the dispatched operator is to initiate a task, the question of access management arises as a practical matter. For example, suppose the electric power supply facility in a condominium has failed. The operator enters the building and goes inside the compartment where the power supply facility is installed. He or she might also need to open the control panel of the facility. All these steps usually require a number of keys, which the worker typically borrows from the manager or administrator of the building.

In recent years, so-called gate control technologies have been developed and it is now possible to open doors not with physical keys but with the entry of a password or the presentation of an ID card on which key information is recorded. The use of such keys, known as “logic keys,” is expected to be the dominant access management tool in the future.

Further, when the operator wants to obtain information regarding parts or specifications, such as a manual, for the maintenance of a facility or equipment in the condominium, for example, he or she usually contacts the building's manager or administrator, monitoring-center personnel, or the manufacturer of the equipment. However, people such as the manager of the condominium or the monitoring-center personnel are not usually knowledgeable about the relevant technical matter and are often incapable of offering appropriate responses to the operator's inquiry. This problem is being partly addressed by the use of portable terminals, which allow the operator to access a database of parts or specification information. In this case, however, the operator still has to enter a password for access to the database, and he or she has to first contact the monitoring center (typically the monitor worker) and ask for an appropriate password.

JP Patent Publication (Kokai) Nos. 2001-222621 A (“Maintenance-assisting terminal apparatus, maintenance management apparatus, and maintenance-assisting method”) and 2001-111704 A (“Building management system”) disclose methods and apparatus for improving the efficiency of access management in maintenance operation. The former relates to a method and system in which a necessary access right is granted to maintenance personnel based on a maintenance schedule (indicating the identity of maintenance personnel and the date and nature of maintenance). The latter relates to a system whereby terminal devices are prevented from accessing, via communication lines, building management systems other than designated ones.

JP Patent Publication (Kokai) Nos. 2001-76270 A (“Security system”) and 2000-137884 A (“Building management apparatus”) disclose methods and systems for granting log-on rights to terminal devices based on personal authentication before entry into a facility or room.

JP Patent Publication (Kokai) Nos. 2000-330623 A (“Wide-area operation system”) and 2000-30171 (“Access-right level setting method”) disclose methods and systems for hierarchically managing the right of access to building management systems based on organization or the importance of data.

JP Patent Publication (Kokai) Nos. 10-27199 A (1998) and 6-321451 A (1994) disclose access management techniques for maintenance operation using maintenance terminal devices. The former (“Routine maintenance operation chart creating apparatus”) relates to an exclusive control for preventing the overwriting of common information by multiple users when creating a routine maintenance operation chart using a client-server system. The latter (“Method of supplying, storing, and displaying elevator control data”) relates to the centralized management of common parameters for elevator control and the supply of unique parameters via a memory card.

In the above-mentioned example of the failed electric power supply facility in a condominium, if the failure occurred late at night or on a holiday, the manager or administrator of the building would be more likely to be absent, which would make it difficult to obtain the necessary keys to the building, a room, or control panel of the relevant facility.

### SUMMARY OF THE INVENTION

It is therefore an object of the invention to reduce the burden on managers, administrators, operators, or monitoring-center personnel regarding so-called access management operations including the visit to and operation of a facility, installation, or equipment, in order to improve the efficiency of such operations (such as reduction of time and costs) and increase customer satisfaction.

In order to achieve the object of the invention, the invention provides access managing apparatus, maintenance operation-assisting access managing apparatus, access management object apparatus, maintenance operation access management object apparatus, and methods therefor. According to these apparatuses and methods, when requesting an operation, logic keys are extracted in advance that provide the right of access that would be required in a series of operations to be implemented by the operator. These logic keys or their temporary versions are then used for the management of access.

In one aspect, the invention provides an access management apparatus for managing operations involving an access management object apparatus, the access management apparatus capable of communicating via a network with an electronic device possessed by, an operator, the access management apparatus comprising:

an access right establishing unit for establishing the right of access to the access management object apparatus that is necessary for implementing a given operation procedure; and

an access-right managing unit for transmitting the access right established by the access right establishing unit to the electronic device.

The access management apparatus preferably comprises an operation procedure creating unit for setting an access management object apparatus necessary for dealing with a given operation event and creating an operation procedure comprised of a sequence of access management object apparatuses in the order of operation.

When the operation is a maintenance operation on a facility, installation or equipment, the invention provides a maintenance operation-assisting access management apparatus for managing maintenance operation involving a maintenance operation access management object apparatus, the maintenance operation-assisting access management apparatus capable of communicating with an electronic device possessed by a maintenance operator via a network, the maintenance operation-assisting access management apparatus comprising:

an access right establishing unit for establishing the right of access to the maintenance operation access management object apparatus necessary for implementing a given maintenance procedure; and

an access-right managing unit for transmitting the access right established by the access right establishing unit to the electronic device.

The maintenance operation-assisting access management apparatus preferably comprises an access right storage unit for storing knowledge associating maintenance procedures and access rights, wherein

the access right establishing unit establishes the access right based on the maintenance procedure-access right associating knowledge stored in the access right storage unit.

For security considerations, the access-right managing unit may erase the access right transmitted to the electronic device after the completion of maintenance operation.

The maintenance operation-assisting access management apparatus preferably comprises a maintenance procedure creating unit for setting a maintenance operation access management object apparatus necessary for dealing with a given maintenance operation event and creating a maintenance procedure comprised of a sequence of maintenance operation access management object apparatus in the order of maintenance operation.

The maintenance operation-assisting access management apparatus preferably comprises a maintenance procedure storage unit for storing knowledge associating maintenance operation events and maintenance procedures, wherein

the maintenance procedure creating unit creates a maintenance procedure based on the maintenance operation event-maintenance procedure associating knowledge stored in the maintenance procedure storage unit.

Preferably, in the maintenance operation-assisting access management apparatus, which is capable of communicating with a maintenance operation access management object apparatus via a network,

the access right establishing unit establishes a temporary access right for accessing the maintenance operation access management object apparatus temporarily, wherein the temporary access right is transmitted by the access-right managing unit to the access management object apparatus and the electronic device and is erased after operation. Thus, more consideration can be given to security by establishing temporary access rights.

Preferably, in the maintenance operation-assisting access management apparatus, the maintenance procedure includes a conduct procedure in order for the maintenance operator to arrive at the maintenance operation access management object apparatus. The maintenance procedure may further include an operation procedure to which the operator is obligated based on a contract.

In another aspect, the invention provides an access management object apparatus that requires an access right for operation, wherein the apparatus can be accessed using the access right transmitted from the access management apparatus.

In still another aspect, the invention provides a maintenance operation access management object apparatus that requires an access right for operation, wherein the apparatus can be accessed using the access right transmitted from the maintenance operation-assisting access management apparatus.

The invention also provides an access managing method and a maintenance operation-assisting access managing method that have similar features. Thus, the invention can reduce the burden on the people involved in access managing operations, enhance the efficiency of the operation (including reduced time and cost), and increase customer satisfaction.

### BRIEF DESCRIPTION OF THE DRAWINGS

FIG. 1 shows a diagram of an access management apparatus according to an embodiment of the invention.

FIG. 2 shows a diagram of a maintenance operation-assisting system according to a first embodiment of the invention.

FIG. 3 shows an example of the data structure of a maintenance request.

FIG. 4 shows a maintenance procedure creating step.

FIG. 5 shows an example of the maintenance procedure creating knowledge.

FIG. 6 shows an example of maintenance procedure information.

FIG. 7 shows an access right establishing step.

FIG. 8 shows an example of an access right item.

FIG. 9 shows an example (1) of the access right knowledge.

FIG. 10 shows an example (2) of the access right knowledge.

FIG. 11 shows an example (3) of the access right knowledge.

FIG. 12 shows an example (1) of the access right information.

FIG. 13 shows an access-right managing step.

FIG. 14 illustrates the coordination with a gate controller.

FIG. 15 illustrates the coordination between a maintenance terminal and a maintenance database managing apparatus.

FIG. 16 shows a diagram of the maintenance operation-assisting system according to a second embodiment.

FIG. 17 shows an example (2) of the access right information.

FIG. 18 shows a maintenance operation bidding method.

### DESCRIPTION OF PREFERRED EMBODIMENTS

The invention will be hereafter described by way of embodiments with reference made to the drawings.

A first embodiment concerns an access management apparatus as used in a maintenance operation-assisting system. A second embodiment concerns a maintenance operation-assisting system in which an access management apparatus is connected to an access management object apparatus via a network.

(First Embodiment)

The first embodiment, in which an access management apparatus is used in a maintenance operation-assisting system, will be described by referring to the drawings.

(Access Management Apparatus and Maintenance Operation-Assisting Access Management Apparatus)

An access management apparatus is capable of communicating with an electronic device possessed by a operator via a network. It manages operations involving an apparatus as the object of access management (“access management object apparatus”), as will be described later. The access management apparatus includes an access right establishing unit for establishing the right of access to the access management object apparatus necessary for implementing a given operation procedure. It also includes an access-right managing unit for transmitting the access right established by the access right establishing unit to the electronic device.

The access management apparatus also includes an operation procedure creating unit for setting an access management object apparatus necessary for the dealing with a given operation event, and for creating an operation procedure made up of a sequence of access management object apparatus in the order of operation.

When the operation is a maintenance operation, a maintenance operation-assisting access management apparatus is capable of communicating with an electronic device possessed by a maintenance operator via a network. It manages maintenance operation involving a maintenance operation access management object apparatus. The maintenance operation access management apparatus includes an access right establishing unit for establishing the right of access to the maintenance operation access management object apparatus necessary for implementing a given maintenance procedure. It also includes an access-right managing unit for transmitting the access right set by the access right establishing unit to the electronic device.

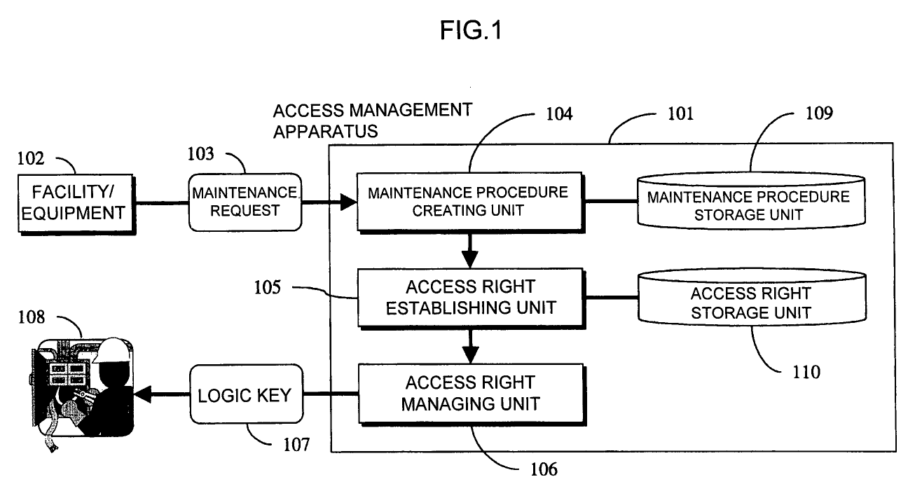

FIG. 1 shows a diagram of an access management apparatus 101.

In the case of maintenance operation, the access management apparatus 101 includes a maintenance procedure creating unit 104, an access right establishing unit 105, and an access-right managing unit 106. The maintenance procedure creating unit 104 generates a maintenance procedure to be implemented in response to a maintenance request 103 received from a facility/equipment 102 at the maintenance site, such as, for example, a building, elevator, manufacturing equipment at a factory, plant equipment, or a power or railroad facility. The access right establishing unit 105 extracts access right information necessary for the maintenance operator to implement the maintenance procedure on the site. The access-right managing unit 106 creates, based on the access right information, a logic key 107 to which an access right is given that is necessary for implementing the maintenance procedure, and manages the life cycle of the logic key.

The maintenance request 103 includes the type of event that occurred (such as an error code or a routine maintenance request message), information concerning the facility/equipment that needs maintenance, information concerning the location of the maintenance site, and information concerning the date of issuance of the request.

The access management apparatus 101 includes a control device, a storage device unit, and an input/output device. The storage unit stores programs (not shown) for realizing the function of each of these devices, and the programs are activated as necessary. Thus, the programs cause these devices to function as the maintenance procedure creating (104), access right establishing (105), and access-right managing (106), for example.

(1) Maintenance Procedure Creating Unit

The maintenance procedure creating unit 104 characteristically sets the maintenance operation access management object apparatus necessary for dealing with a given maintenance operation event, and generates a maintenance procedure comprised of a sequence of maintenance operation access management object apparatuses in the sequence of maintenance operation.

The maintenance procedure creating unit 104 also characteristically generates a maintenance procedure based on the knowledge about the association of maintenance operation events with maintenance procedures stored in a maintenance procedure storage unit 109, as will be described later.

The maintenance procedure characteristically includes a conduct procedure to be followed before the maintenance operator arrives at the maintenance operation access management object apparatus, and an operation procedure to which the worker is obligated by contract.

As shown in FIG. 1, the maintenance procedure creating unit 104 creates an appropriate maintenance procedure, namely a sequence of maintenance operation, in response to the maintenance request 103 from the facility/equipment 102, using the maintenance procedure storage unit 109, in which associations of at least events that occurred and maintenance procedures are recorded.

The maintenance procedure creating unit 104 also creates a maintenance procedure including a procedure for arriving at the maintenance object apparatus (such as procedures for entering a building or a room), and operations that must be carried out due to contractual obligations between the monitoring/maintenance center and the maintenance operator.

(2) Access Right Establishing Unit

The access right establishing unit 105 characteristically establishes an access right based on the knowledge about the association of maintenance procedures with access rights, as will be described later, that are stored in an access right storage unit 110.

Specifically, the access right establishing unit 105 extracts access right information (namely a logic key 107) using the access right storage unit 110. The access right information is needed for the maintenance operator to carry out the maintenance procedure created by the maintenance procedure creating unit 104. The access right information includes electronic key information for entry into a facility or a room, a password for logging in to a terminal of the control apparatus, and a password for accessing databases of parts or specification information. In the access right storage unit 110, at least individual maintenance operations and access right information necessary for implementing the maintenance operations are stored as associated with one another.

(3) Access Right Managing Unit

The access-right managing unit 106 characteristically transmits the access right established by the access right establishing unit 105 to the electronic device, and erase the access right transmitted to the electronic device after the maintenance operation.

Specifically, the access-right managing unit 106 notifies a maintenance operator 108 of the access right information extracted by the access right establishing unit 105 or a new logic key 107 in which access right information has been compiled. The logic key 107 is preferably stored in a portable electronic medium possessed by the maintenance operator 108 and read out when entering a facility or room, or when logging in to a control terminal, for example. The logic key 107 can be erased after the maintenance operation.

(Access Management Object Apparatus and Maintenance Operation Access Management Object Apparatus)

An access management object apparatus requires an access right for operation and is characteristically accessible with an access right transmitted from the access management apparatus.

A maintenance operation access management object apparatus requires an access right for operation and is characteristically accessible with an access right transmitted from the maintenance operation assist access management apparatus.

The access management object apparatus and the maintenance operation access management object apparatus include, for example, a building, an elevator, production equipment at a factory, plant equipment, power or railroad facilities or equipment, or, as will be described later, a control apparatus or a gate controller. They require the logic key, which is the access right, for operation when the operator operates on them. As will be described in detail later, the gate controller, for example, receives the logic key from the operator's maintenance terminal, and instructs a lock opening/closing device to open or close the door if the logic key is valid.

Thus, when implementing a maintenance operation on a facility or equipment, the access management apparatus 101 automatically extracts necessary access right information depending on the content of the maintenance operation and then generates a logic key connoting relevant access rights. The maintenance operator can thus enter the facility or room using the logic key, log in to the control terminal, and implement the maintenance operation smoothly while referring to the desired database.

(Maintenance Operation-Assisting System)

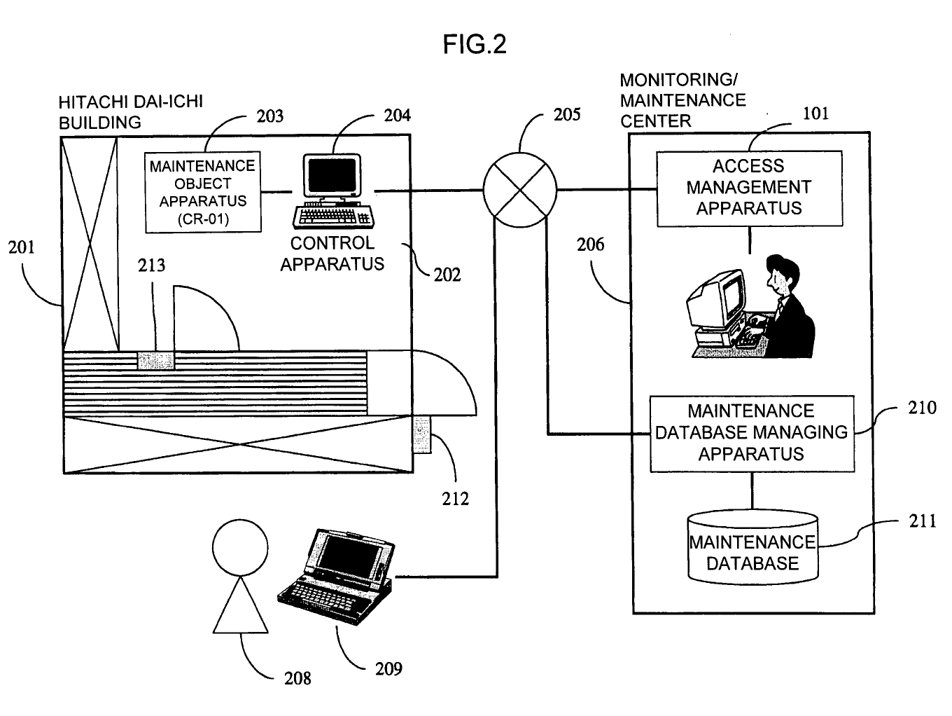

FIG. 2 shows a diagram of a maintenance operation-assisting system employing the access management apparatus 101.

It is assumed that a maintenance object apparatus (CR-01) 203 installed in an equipment room 202 of a Hitachi Dai-ichi Building 201 has failed and is in need of maintenance.

A control apparatus 204 is connected to the maintenance object apparatus (CR-01) 203. The control apparatus 204 locally controls the maintenance object apparatus (CR-01) 203 and monitors the operation thereof, for example. The control apparatus 204 is also connected via a network 205, such as a private or public line, to an access management apparatus 101 at a monitoring/maintenance center 206, so that it can deliver various types of information concerning the operation of the maintenance object apparatus 203 to the access management apparatus 101.

A maintenance database 211 stores information concerning buildings or customers, specification information about various devices and equipment, maintenance manuals, and various report forms, for example. The maintenance database 211 is connected via a maintenance database management apparatus 210 to the network 205. Thus, one can refer to the contents of the database or register report information using an external network terminal as long as one has a predetermined access right.

The access management apparatus 101 is also capable of being connected via the network 205, such as a private or public line, to a portable maintenance terminal 209 in the hands of the maintenance operator 208. Thus, a maintenance request message or the logic key for access management during maintenance can be transmitted.

The entrance door to the Hitachi Dai-ichi Building 201 and that to the equipment room 202 are equipped with a gate controller 212 and a door controller 213, respectively, so that the doors cannot be opened without the logic key. The manner in which the logic key is entered into the gate controller 212 or the door controller 213 is not particularly limited in the present invention. Examples include the use of a numeric keypad, an ID card, and short-distance wireless techniques such as Bluetooth.

Now a case is considered where a failure occurred in the maintenance operation apparatus (CR-01) 203. The failure is detected by the control apparatus 204, which then compiles a maintenance request 103 as shown in FIG. 1 and transmits it to the access managing apparatus 101 via the network 205. The specific manner of failure detection and the method of communicating maintenance request are not particularly limited in the present invention, and existing monitoring/control systems or communication systems may be employed.

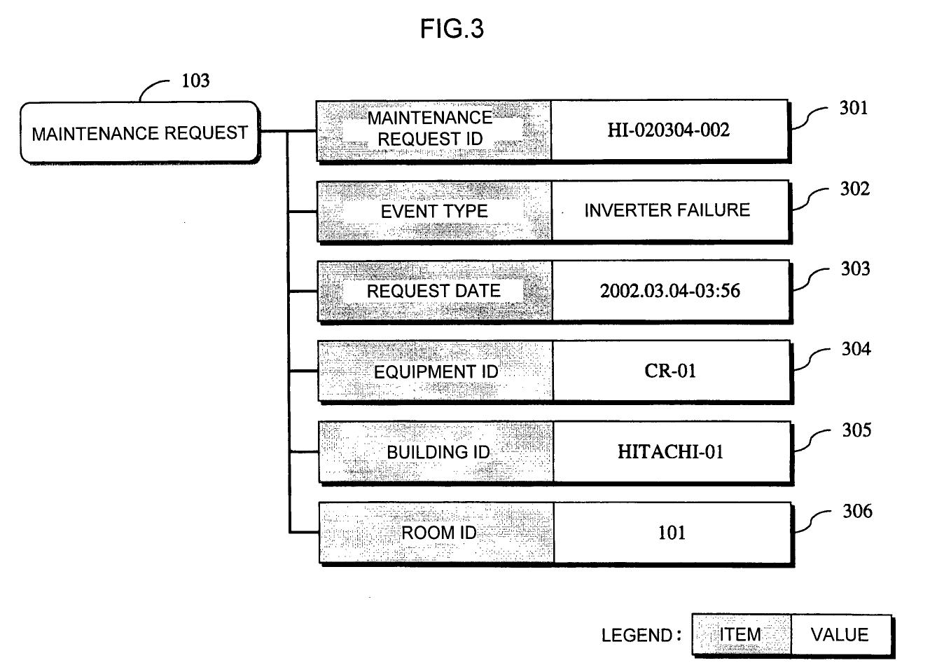

FIG. 3 shows an example of the data structure of the maintenance request 103. In this example, the maintenance request 103 has six data items. A maintenance request ID 301 is a management number the control apparatus 204 gives to the maintenance request 103. It is HI-020304-002 in this example. An event type 302 indicates the type of the maintenance request 103, such as an error code for a particular type of trouble that has occurred, or a routine maintenance request message. In the example of FIG. 3, the event type 302 indicates the occurrence of an inverter failure. A request date 303 indicates the date and time of the issuance of the maintenance request by way of a code that, in this example, is “2002. 03. 04-03:56,” meaning 3:56 in the morning of Mar. 4, 2002. An equipment ID 304 is the management code of the equipment in which the inverter failure took place. The code in this example is CR-01. A building ID 305 is the management code of the building in which the equipment is installed. The code in this example is HITACH-01. A room ID 306 is the management code of the room in which the equipment is installed, which is 101 in this example, indicating the equipment room.

While in the example of FIG. 3 the building ID 305 and the room ID 306 are indicated, these items may be omitted when the building ID 305 and room ID 306 can be obtained from the equipment ID 304 based on an equipment location table (not shown) on the part of the access management apparatus 101.

(Access Management Method)

An access management method is used in managing operations involving an access management object apparatus by communicating with the operator's electronic device via a network. The access management method characteristically includes the step of establishing the right of access to the access management object apparatus that is necessary for the implementation of a given operation procedure, and the step of transmitting the thus established access right to the electronic device.

The access management method characteristically includes the step of setting the access management object apparatus necessary for dealing with a given operation event and generating an operation procedure comprised of a sequence of access management object apparatuses in the order of operation.

When the operation is a maintenance operation, a maintenance operation-assisting access management method is used in managing maintenance operation involving a maintenance operation access management object apparatus by communicating with the maintenance operator's electronic device via a network. The method includes the step of establishing the right of access to the maintenance operation access management object apparatus necessary for the implementation of a given maintenance procedure, and the step of transmitting the thus established access right to the electronic device.

Specifically, in the case of a maintenance operation, the access management method activates the step of creating a maintenance procedure in response to the maintenance request 103 in order to create a maintenance procedure, that is, a sequence of maintenance operation, using the maintenance request 103 and the maintenance procedure storage unit 109.

Then, the step of establishing an access right is activated, followed by the activation of the access-right managing step, whereby the access right is transmitted to the maintenance terminal, such as the electronic device.

(1) Maintenance Procedure Creating Step

The maintenance procedure creating step includes the step of setting an access management object apparatus necessary for dealing with a given maintenance operation event and creating a maintenance procedure comprised of an arrangement of access management object apparatuses in the order of maintenance operation.

The maintenance procedure creating step includes the step of creating a maintenance procedure based on the knowledge about the association of maintenance operation events and maintenance procedures.

The maintenance procedure further includes the step of creating a maintenance procedure including a conduct procedure to be followed by the maintenance operator before arriving at the access management object apparatus and an operation procedure to be followed by the maintenance operator due to contractual obligations.

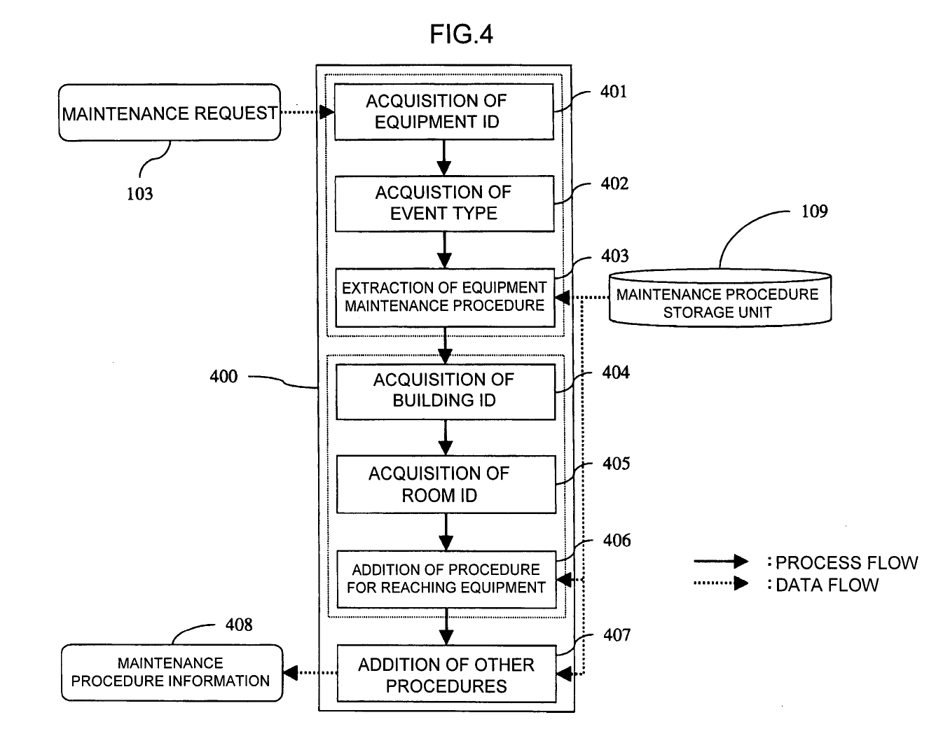

FIG. 4 shows a maintenance procedure creating step 400. In the preset embodiment, the maintenance procedure creating step is comprised of seven steps from step 401 to step 407. These steps could be considered as consisting of three processing groups, namely a processing step group of steps 401 to 403 for creating a maintenance procedure concerning equipment, a processing step group of steps 404 to 406 for creating a procedure for the maintenance operator 208 before arriving at the location of the equipment, and a processing step group of step 407 for creating other necessary maintenance procedures.

In the maintenance procedure creating step 400, equipment ID is obtained in step 401 upon reception of the maintenance request 103. The equipment ID in the present embodiment is “CR-01” as shown in FIG. 3. In step 402, the event type is obtained, which in this case is “inverter failure,” as shown in FIG. 3. In step 403, the maintenance procedures for various devices or types of equipment are extracted from the maintenance procedure storage unit 109, using the equipment ID and the event type as a key. In the maintenance procedure storage unit 109, the knowledge is stored in advance about which maintenance procedure should be implemented with regard to a certain type of failure in a certain apparatus. The maintenance procedure storage unit 109 thus stores in advance the maintenance procedures in association with the equipment IDs and event types.

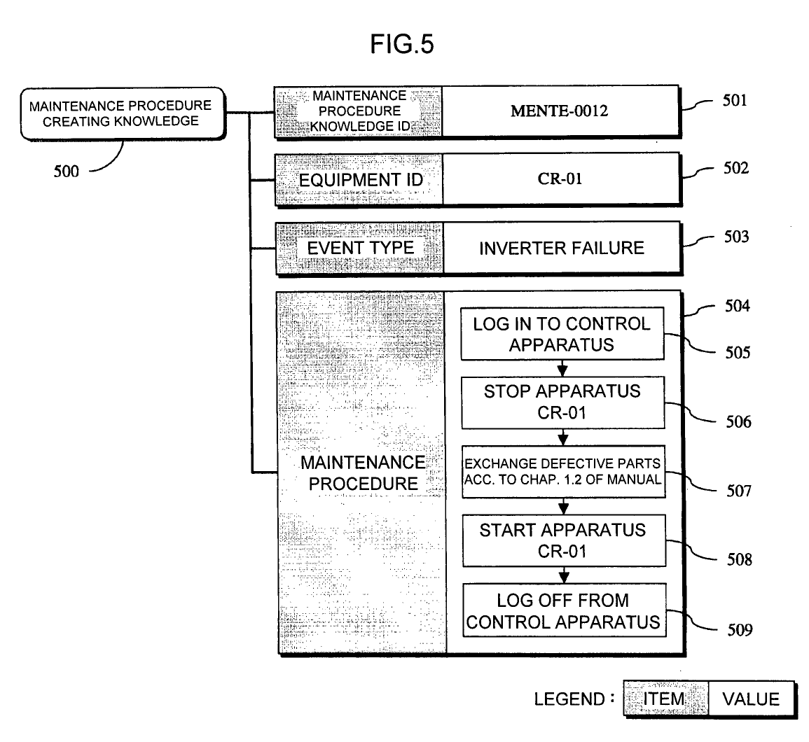

FIG. 5 shows an example of the knowledge for creating a maintenance procedure.

Maintenance procedure creating knowledge 500 is extracted in step 403. The maintenance procedure creating knowledge 500 relates to a case where the equipment ID 502 is CR-01 and the event type 503 is an inverter failure. The knowledge includes a maintenance procedure knowledge ID 501 of “MENTE-0012” and a maintenance procedure 504 consisting of steps 505 to 509.

In step 404, the building ID is obtained, which is “HITACHI-01” in the present embodiment, as shown in FIG. 3. In step 405, the room ID is obtained, which is, in the present embodiment, “101,” as shown in FIG. 3.

In step 406, a maintenance procedure is created by adding a procedure for reaching the apparatus (i.e., the entry into the building or the room) to the maintenance procedures 505 to 509 shown in FIG. 5.

In step 407, other maintenance operations, such as those that must be implemented for reasons of contract between the monitoring/maintenance center and the maintenance operator, for example, are incorporated into the thus created new maintenance procedure, thus creating final maintenance procedure information 408. These other maintenance operations are also stored in the maintenance procedure storage unit 109 in advance. In the present example, it is assumed that the maintenance operator must report the completion of work to the monitoring/maintenance center after exiting the building.

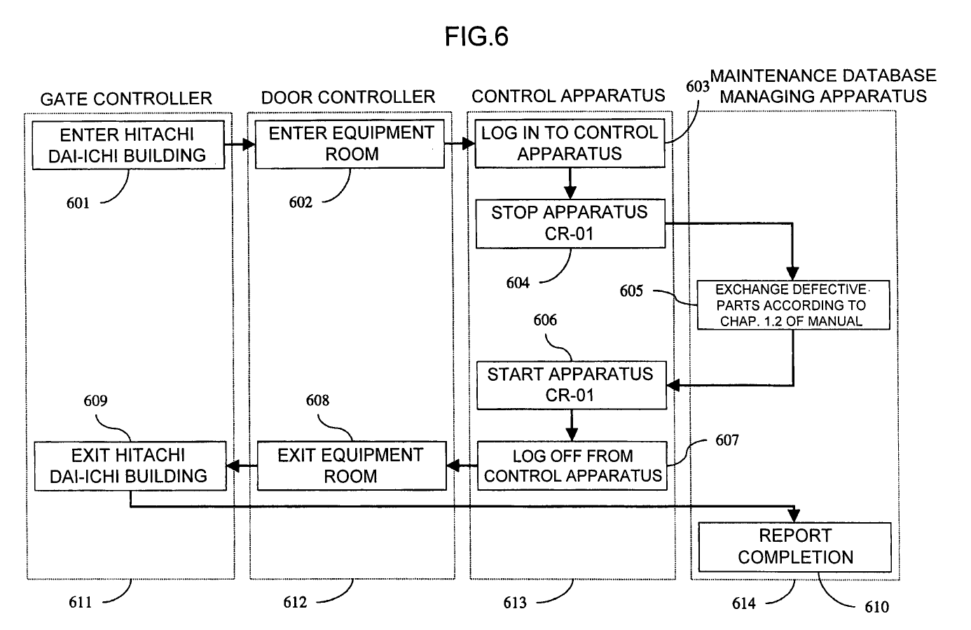

FIG. 6 shows the maintenance procedure information 408 generated as a result of the above described processes. The maintenance procedure shown in FIG. 6 consists of 10 maintenance steps, namely steps 601 to 610. These steps characteristically include operations to be carried out before arriving at the location of the maintenance object apparatus or operations that must be carried out for contractual reasons, as well as the operations for maintenance. These maintenance procedures can be divided into an operation group 611 relating to the gate controller 212, an operation group 612 relating to the door controller 213, an operation group 613 relating to the control apparatus 204 and the maintenance object apparatus (CR-01) 203, and an operation group 614 relating to the maintenance database management apparatus 210, as shown in FIG. 6.

(2) Access Right Establishing Step

In the access right establishing step, an access right is established based on the association knowledge between maintenance procedures and access rights.

Specifically, in the access right establishing step, access right information that is needed for implementing the maintenance procedure information 408 generated by the maintenance procedure creating step 400 is extracted based on the maintenance operation-access right information associating knowledge stored in the access right storage unit 110.

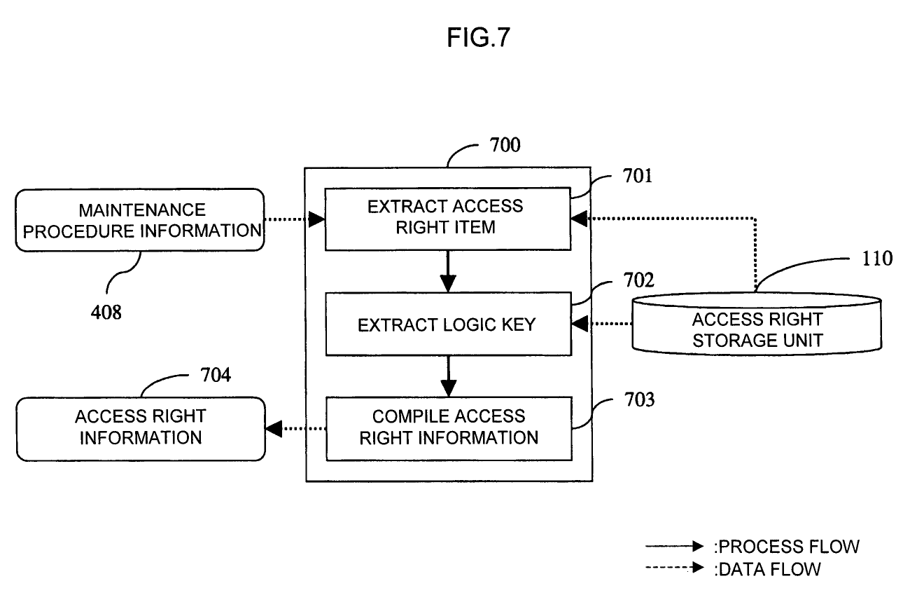

FIG. 7 shows an access right establishing step 700. Step 701 is carried out upon reception of the maintenance procedure information 408. In step 701, individual items of the maintenance operation information in the maintenance procedure information 408 are examined and necessary access right items are extracted. The access right items refer to the names (items, indexes) of the access rights necessary for implementing a given operation. In the present embodiment, the “maintenance operation-access right item associating knowledge” is stored in the access right storage unit 110 in advance.

In the maintenance procedure shown in FIG. 6, the “maintenance operation-access right item associating knowledge” as will be described below is extracted.

In order to implement “Enter Hitachi Dai-ichi Building” in the maintenance step 601, a “logic key to the gate controller at the Hitachi Dai-ichi Building” is needed.

In order to implement “Enter equipment room” in the maintenance step 602, a “logic key to the equipment room electronic door” is needed.

In order to implement “Log in to control device” in the maintenance step 603, a “control device (204 in FIG. 2) log-in password” is needed.

In order to implement “Stop apparatus CR-01” in the maintenance step 604, “a CR-01 (203 in FIG. 2) shutdown password” is needed.

In order to implement “Exchange defective parts according to Chap. 1.2 of manual” in the maintenance step 605, a “guest-user log-in password” for access to the maintenance database management apparatus (210 in FIG. 2) is needed, so that an electronic maintenance manual stored in the maintenance database (211 in FIG. 2) can be referred to.

In order to implement “Report completion” in the maintenance step 610, a “log-in password for access to the operation report management function” in the maintenance database management apparatus (210 in FIG. 2) is needed.

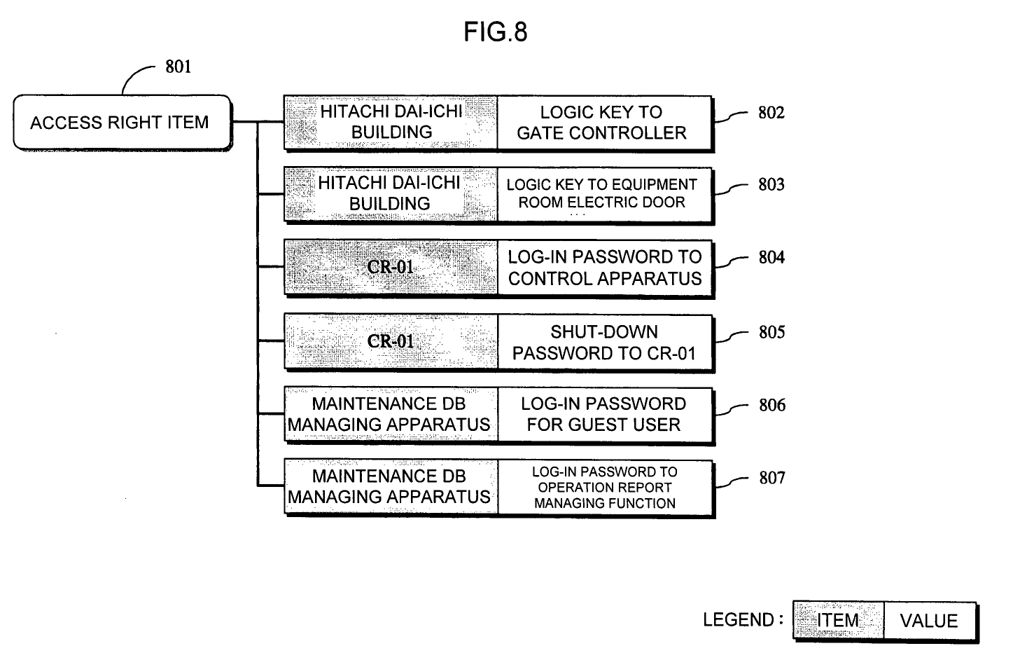

As a result of the access right item extraction process in step 701, an access right item 801 is extracted in the present embodiment, as shown in FIG. 8.

In step 702, logic keys are extracted that corresponds to the individual items of the access right item 801 based on the access right knowledge stored in the access right storage unit 110 in advance.

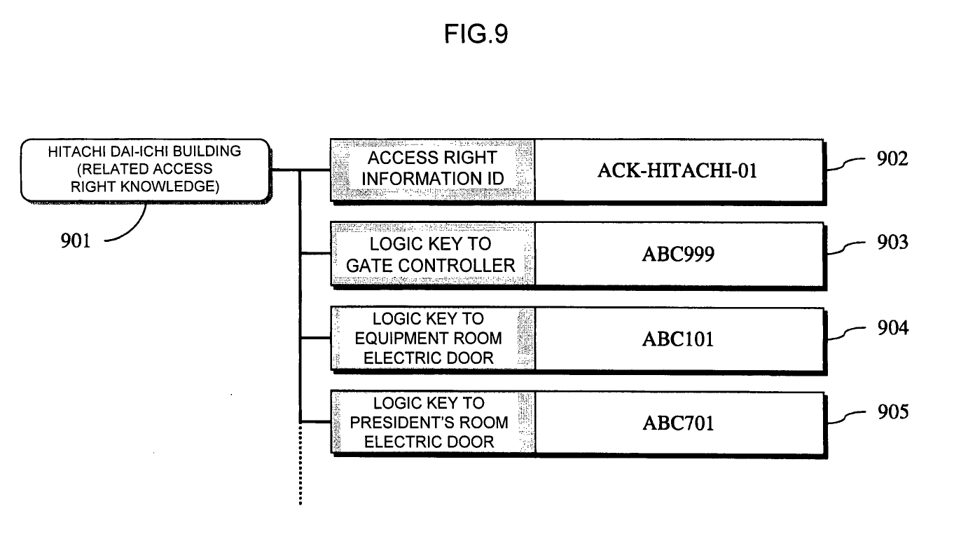

FIGS. 9, 10 and 11 show examples of the access right knowledge. Numeral 901 in FIG. 9 designates the access right knowledge concerning the Hitachi Dai-ichi Building. This knowledge shows that the value of the logic key corresponding to the access right item “Gate controller logic key” is “ABC999” (903), and that the value of the logic key corresponding to the access right item “Equipment room electronic door logic key” is “ABC101” (904).

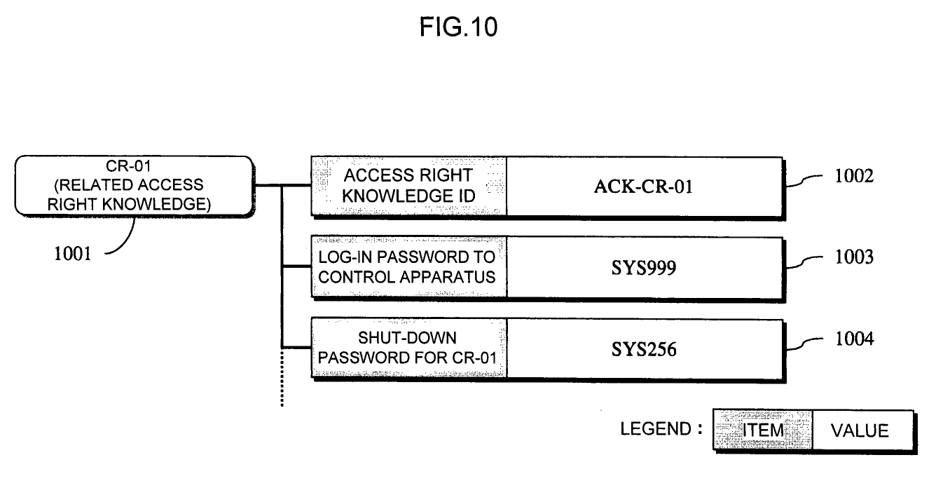

Numeral 1001 in FIG. 10 designates the access right knowledge concerning CR-01. The knowledge indicates that the value of the logic key corresponding to the access right item “Control-device log-in password” is “SY8999” (1003), and that the value of the logic key corresponding to the access right item “CR-01 shutdown password” is “SYS256” (1004).

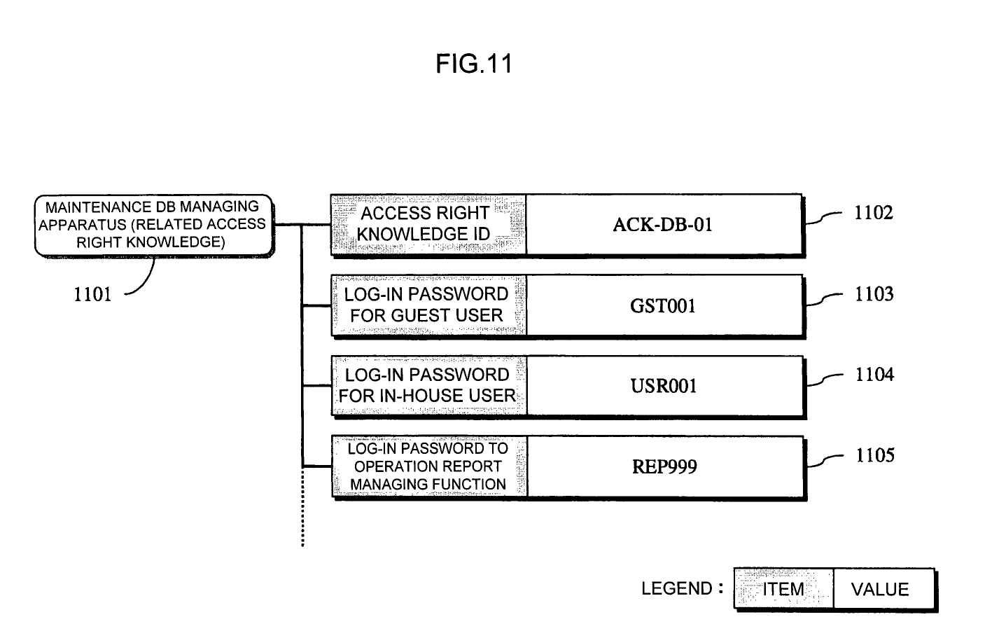

Numeral 1101 in FIG. 11 designates the access right knowledge concerning the maintenance database management apparatus 210 in FIG. 2. The knowledge indicates, for example, that the value of the logic key corresponding to the access right item “Guest-user log-in password” is “GST001” (1103), and that the value of the logic key corresponding to the access right item “Operation report management function log-in password” is “REP999” (1105).

In step 703, the access right item 801 extracted in step 701 and the logic keys extracted in step 702 corresponding to the individual access right items are compiled, thus creating access right information 704.

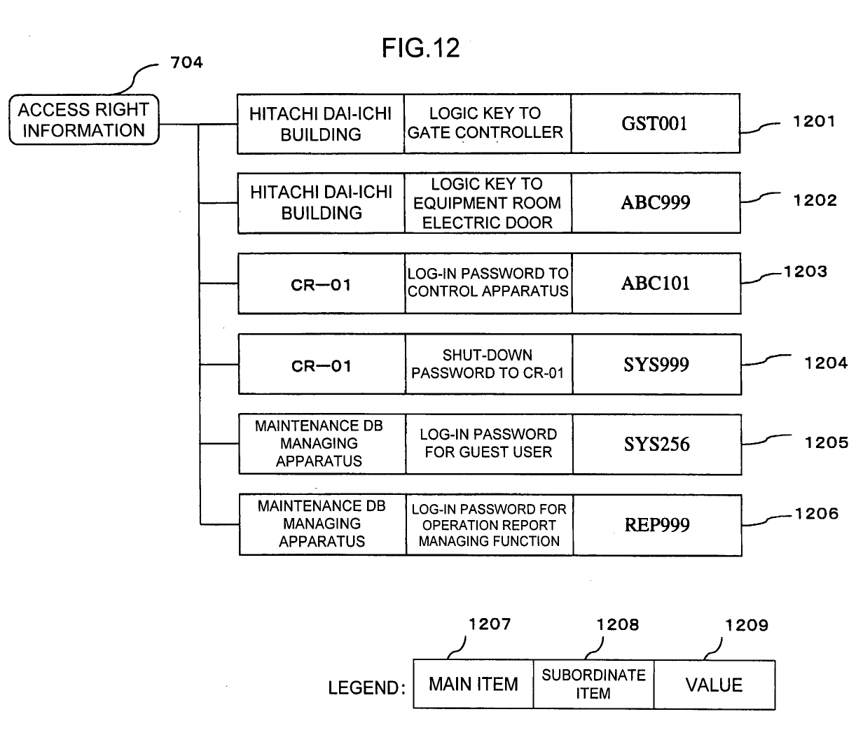

FIG. 12 shows the thus created access right information 704. In FIG. 12, a main item 1207 concerns the object of access management, such as a facility or equipment, and a sub-item 1208 concerns an access right item. In a value 1209, the logic key is recorded.

(3) Access Right Management Step

In the access-right managing step, the access right established in the access right establishing step 700 is transmitted to the electronic device. The thus transmitted access right is erased after the completion of the maintenance operation.

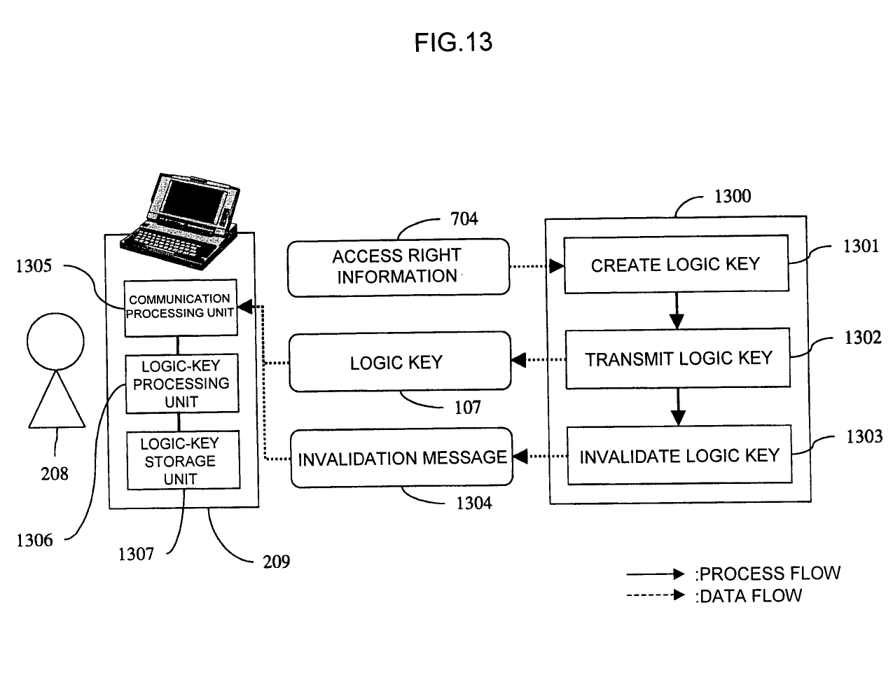

FIG. 13 shows an access-right managing step 1300. Specifically, upon reception of the access right information 704 extracted in the access-right establishing step 700, a logic-key creating step 1301 is activated to create a logic key. The logic key is then transmitted in a logic-key transmitting step 1302 to the predetermined maintenance operator 208. The logic key 107 is preferably stored in a portable electronic medium possessed by the maintenance operator 208, which is, in the present embodiment, the portable maintenance terminal 209.

As shown in FIG. 13, the maintenance terminal 209 in the present embodiment includes a communication processing unit 1305, a logic-key processing unit 1306, and a logic-key storage unit 1307. The logic key 107 is sent via the communication processing unit 1305 to the logic-key processing unit 1306 where it is processed, and then stored in the logic-key storage unit 1307.

The logic key 107 is read out of the maintenance terminal 209 when entering the facility or room, or when logging in to the control terminal.

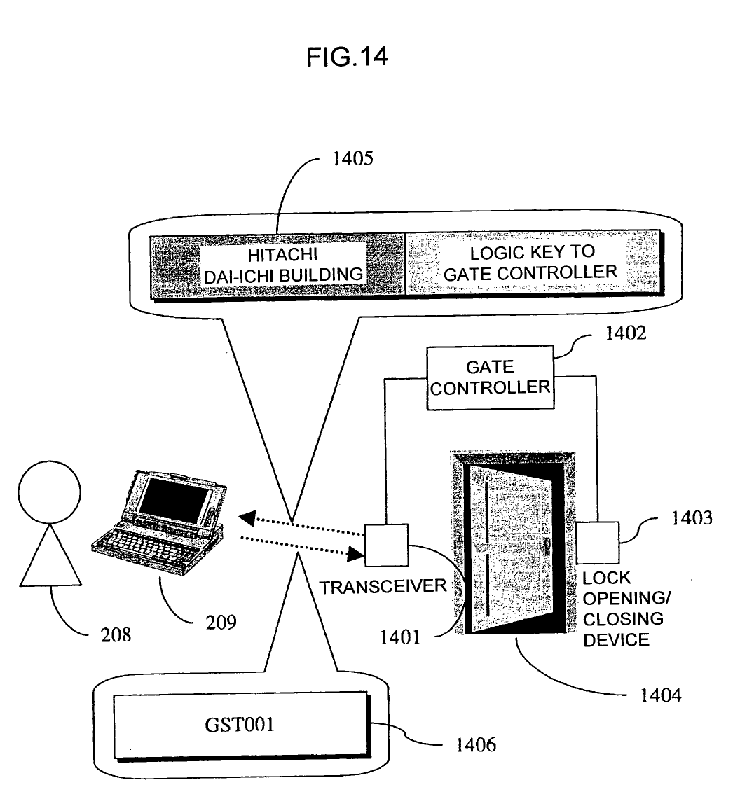

FIG. 14 illustrates the coordination with the gate controller.

For example, as shown in FIG. 14, the portable maintenance terminal 209 in the hands of the maintenance operator 208 and a transceiver 1401 for the gate controller 1402 can exchange access right information using a short-distance wireless technology such as a Bluetooth or wireless LAN (IEEE 802. 11b protocol).

In this case, the transceiver 1401 transmits a message 1405 to the communication processing unit 1305 of the maintenance terminal 209, requesting a logic key from the terminal. In response, the logic-key processing unit 1306 of the maintenance terminal 209 extracts a logic key 1406 (GST001 in the present embodiment) based on the information in the record 1201 of the access right information 704, as shown in FIG. 12, that is stored in the logic-key storage unit 1307. The logic-key processing unit 1306 then transmits the logic key to the transceiver 1401 via the communication processing unit 1305. The logic key is examined by a gate controller 1402. If the logic key is valid, the gate controller 1402 instructs a lock opening/closing apparatus 1403 to open the door.

The manner of communication with the gate controller 1402 or the manner of internal processing is not particularly limited in the present invention and may be based on conventional techniques.

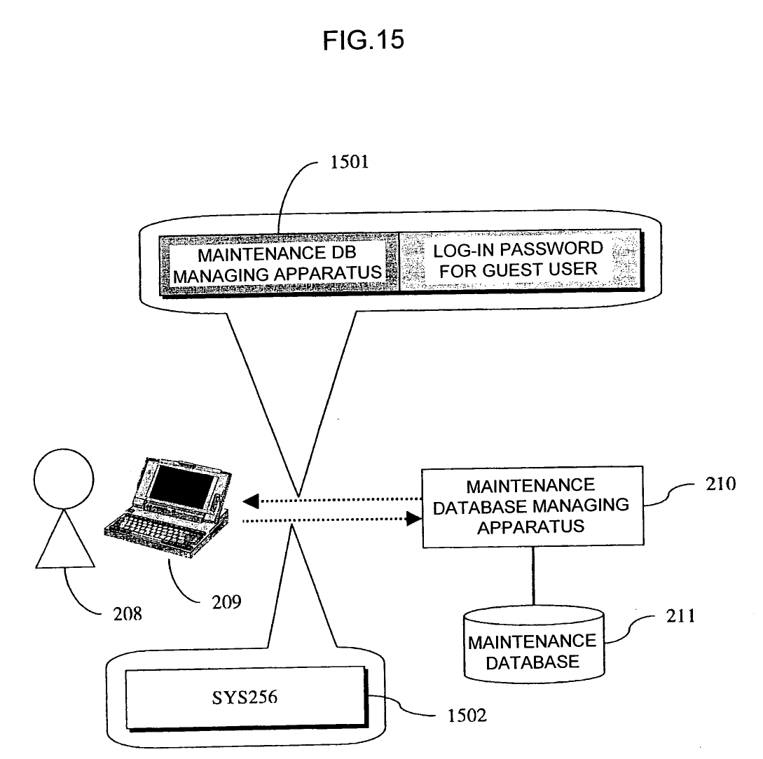

FIG. 15 illustrates the coordination between the maintenance terminal 209 and the maintenance database management apparatus 210. As the maintenance terminal 209 attempts to access the maintenance database management apparatus 210, the maintenance database management apparatus 210 transmits a message 1501 to the communication processing unit 1305 of the maintenance terminal 209, requesting a log-in password. The logic-key processing unit 1306 of the maintenance terminal 209 extracts a logic key 1502 (SY8256 in the present embodiment) based on the information about the record 1205 in the access right information 704, as shown in FIG. 12, which is stored in the logic-key storage unit 1307. The logic-key processing unit 1306 then transmits the logic key back via the communication processing unit 1305. The logic key is then examined by the maintenance database management apparatus 210. If the key is valid, the maintenance database management apparatus 210 grants access to the maintenance database 211 of the maintenance terminal 209. From this time on, the user can obtain information (i.e., the data in Chapter 1.2 of the manual, in the present embodiment) necessary for maintenance operation from the maintenance database 211.

In the present invention, the gate controller 1402, the maintenance database management apparatus 210 or other control devices are authenticated based on the logic key 107 that is obtained using the maintenance terminal 209 in the hands of the maintenance operator 208. The details of the manner of individual authentication processes are not particularly limited.

In a logic-key invalidation process 1303 in the access-right managing step 1300, an invalidation message 1304 for invalidating the logic key 107 is transmitted to the portable maintenance terminal 209 after a certain length of time has passed since the issuance of the logic key 107 to the maintenance terminal 209, or after the end of the maintenance procedure shown in FIG. 6. Upon reception of the invalidation message 1304 via the communication processing unit 1305, the logic-key processing unit 1306 of the maintenance terminal 209 automatically invalidates (erases) the logic key 107 recorded in the logic-key storage unit 1307.

Thus, the maintenance operator 208 cannot enter the Hitachi Dai-ichi Building 201 or access the maintenance database management apparatus 210 after completion of the maintenance operation, thereby increasing the level of security.

While in the present embodiment the logic key for access to the maintenance database 211 is given on the basis of the type of user, it may be given on the basis of the type of event or the type of maintenance operation (such as routine maintenance or emergency operation). In these cases, the range of data that is disclosed to the maintenance operator 208 may be varied depending on the type of the event or maintenance operation, so that access is allowed to only data necessary for the particular type of maintenance operation. This way, the security of the database can be enhanced.

(Second Embodiment)

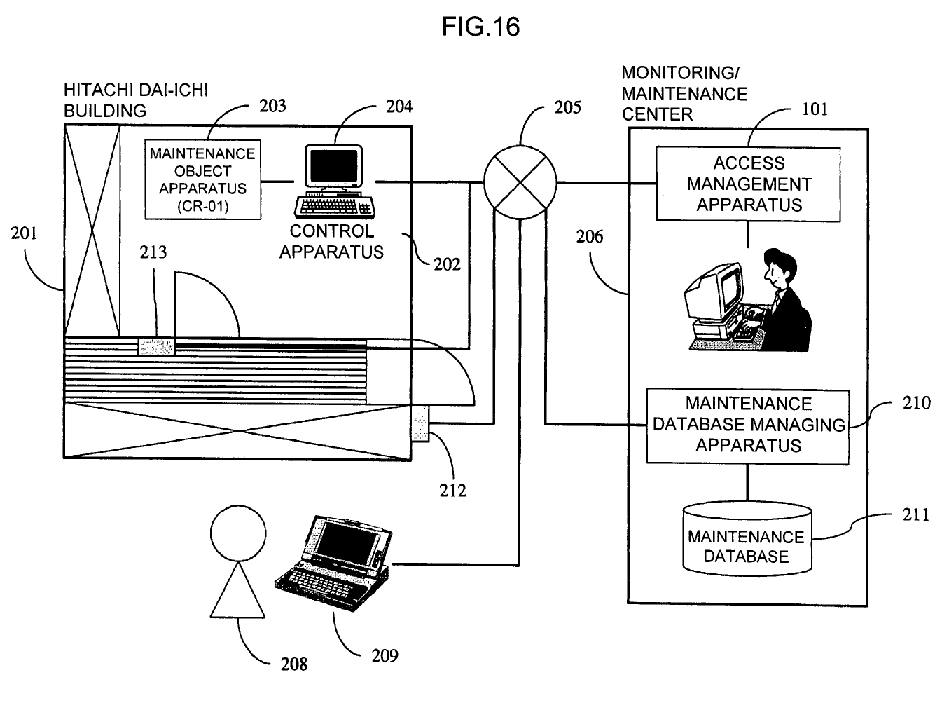

Referring to FIG. 16, a second embodiment concerning a temporary access right will be described. This embodiment is a maintenance operation-assisting system in which the access management apparatus 101 is connected via the network 205 to access management object apparatus such as, for example, the control apparatus 204, the gate controller 212, and the door controller 213.

The access right establishing unit 105 establishes a temporary access right for temporary access to the access management object apparatus. The temporary access right is transmitted by the access-right managing unit 106 to the access management object apparatus and the electronic device and is erased after the operation is over.

In the system shown in FIG. 16, all of the devices involving access right authentication (access management apparatus 101, control apparatus 204, gate controller 212, door controller 213, maintenance database management apparatus 210, and maintenance terminal 209) are connected to the network 205.

In the first embodiment, the logic key 107 provides the access right information 704. Transmitting the access right information 704 itself on the network 205, such as a public line, can be problematic from a security point of view. To avoid this, a temporary logic key is created in a logic-key creating step 1301 in the access-right managing step 1300 shown in FIG. 13 and used for authentication.

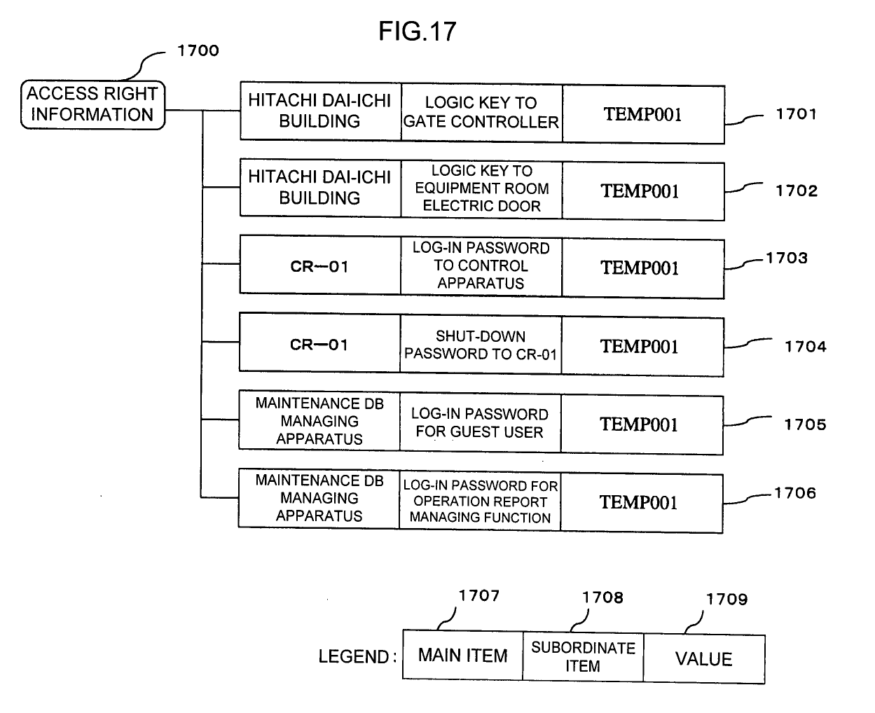

Specifically, instead of the access right information 704 shown in FIG. 12, access right information 1700 is created, as shown in FIG. 17. The access right information 1700 is identical to the access right information 704 in data structure, but the value of every logic key is “TEMP001,” indicating that they are temporary logic keys created in the logic-key creating step 1301.

In a logic-key transmission step 1302 in FIG. 13, each record of the access right information 1700 shown in FIG. 17 is transmitted to a corresponding device.

For example, a record 1701, which is a temporary logic key corresponding to “Logic key to gate controller” for “Hitachi Dai-ichi Building,” is transmitted to the gate controller 212 shown in FIG. 16. The following is a breakdown of this process:

Record 1701→Gate controller 212

Record 1702→Door controller 213

Record 1703→Control apparatus 204

Record 1704→Control apparatus 204

Record 1705→Maintenance database management apparatus 210

Record 1706→Maintenance database management apparatus 210

At the same time as this transmission process, the access right information 1700 is transmitted to the maintenance operator's maintenance terminal 209 and recorded therein.

Each device that receives the temporary logic key (TEMP001) is equipped with a function to regard the temporary logic key as a temporarily valid logic key. For example, the gate controller 212 regards “TEMP001,” as well as “GST001,” which is the original logic key, as valid logic keys.

Thereafter, an authentication process is performed between the maintenance terminal 209 of the maintenance operator 208 and the device requiring authentication, using the logic key “TEMP001.”

In this system, the invalidation message 1304 “Invalidate TEMP001,” which is issued in the logic-key invalidation process 1303, is also transmitted to each device requiring authentication, so that “TEMP001” cannot be used as the logic key anymore thereafter.

The present embodiment is superior from the viewpoint of security because a temporary logic key is used and the authentic logic key for each device requiring authentication is not transmitted over the network. For the same reason, the authentic logic key for each device requiring authentication is not stored in the maintenance operator's maintenance terminal 209. Thus, the maintenance operator 208 is prevented from copying and possessing the authentic logic key and using it for other purposes after the maintenance operation is finished, for example, thus increasing the level of security.

When the individual devices requiring authentication are connected to the network, there is no need for storage of the logic key. Specifically, as long as the access management apparatus 101 stores information concerning to which maintenance terminal 209 in the hands of the maintenance operator 208 the access right item 801 shown in FIG. 8 is given, the authenticating device, upon reception of an access request from the maintenance terminal 209, can refer the access right item 801 via the network 205 and examine whether or not an access right is given to the maintenance terminal from which the access request has been issued.

Thus, the burden on communication and internal processes concerning the transmission and reception of the logic key can be advantageously reduced.

(Business Model)

Hereafter, a maintenance operation bidding method utilizing the access management apparatus will be described.

The maintenance operation bidding method is characterized in that, when a maintenance operation is performed using the access management apparatus, a plurality of maintenance operators enter bids for a given maintenance operation and a winner is selected. The winner is then granted the access right.

The maintenance operation bidding method is characterized in that the maintenance procedure is disclosed to a plurality of maintenance operators.

The maintenance operation bidding method is further characterized in that the maintenance operators participating in a bidding are charged with participation fees.

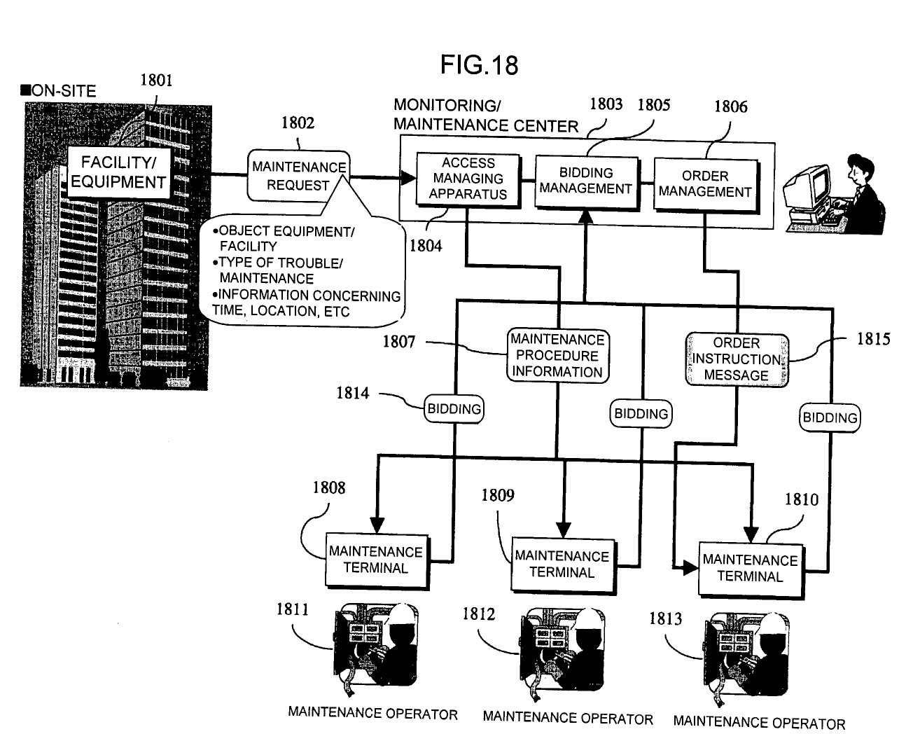

FIG. 18 diagrammatically shows the maintenance operation bidding method according to the invention.

A maintenance request 1802 arrives at a monitoring/maintenance center 1803 from a facility/equipment 1801 such as, for example, a building or a factory. An access management apparatus 1804 according to the invention then discloses maintenance procedure information 1807 (corresponding to 408 in FIG. 4) to maintenance terminals 1808 to 1810 possessed by maintenance operators 1811 to 1813 that are potential bidders.

The maintenance operators 1811 to 1813 then refer to the maintenance procedure information 1807 and transmit bidding information 1814 to a bidding management 1805 at the monitoring/maintenance center 1803. The bidding information 1814 includes information concerning the bidding price and delivery date.

At the monitoring/maintenance center 1803, the bids are evaluated and a maintenance operator (1813 in the illustrated example) who has offered the best bid is selected. Then, an order-instructing message 1815 including the logic key (corresponding to 107 in FIG. 1) is transmitted from the order management unit 1806 to the maintenance terminal 1810 in the hands of the selected operator.

The maintenance operator who has received the order-instructing message 1815 obtains the logic key included in the order-instructing message 1815. Thus, the maintenance operator can gain access authentication as he or she enters the building or room where the door controller is installed, logs in to the control apparatus, or accesses the maintenance database, and then implement maintenance operation according to the maintenance operation information 1807.

The above-described maintenance operation bidding method has the following advantages.

Advantages for the Monitoring/Maintenance Center:

Efficiency of maintenance and order managing operations can be enhanced.

Maintenance operators can be charged with membership fees or rental fees for the maintenance terminals.

Bids from multiple maintenance operators can be compared, so that the order price can be reduced while maintaining the quality.

Advantages for the Maintenance Operators:

Opportunities to participate in a bidding are equally given.

The maintenance procedure is disclosed in advance, so that proper estimates can be made.

Maintenance operation can be implemented efficiently using the logic key.

Advantages for the Client (End-User):

Maintenance operations can be performed quickly.

Facility/equipment management fees can be reduced indirectly as a result of reduction of the order price paid to the maintenance operator.

The manner in which the above maintenance operation bidding method is realized as a system is not particularly limited in the present invention. Thus, the system can be realized using existing client/server implementation technologies, Web server implementation technologies, or other programming technologies.

While preferred embodiments have been described, many other modifications or variations of the invention are possible. For example, the invention can be applied to the case of entry into and operation of a facility, installation or equipment for a home-delivery business.

Thus, in accordance with the invention, when a facility, installation or equipment is visited and operated, a variety of kinds of access right information that are needed depending on the content of operations are automatically extracted along with the operation procedure. Then, a logic key is created that includes the access rights. Thus, the operator can implement the relevant operations smoothly using the logic key.

Further, the invention can speed up operations, reduce costs, and increase customer satisfaction.

Further, the maintenance operation bidding method according to the invention can reduce the order price paid to the maintenance operator and speed up the maintenance operation.

What is claimed is:

1. An access management apparatus for managing operations involving an access management object apparatus, the access management apparatus capable of communicating via a network with an electronic device possessed by an operator, the access management apparatus comprising:
an access right establishing unit for establishing the right of access to the access management object apparatus that is necessary for implementing a given operation procedure; and
an access-right managing unit for transmitting the access right established by the access right establishing unit to the electronic device.

2. The access management apparatus according to claim 1, further comprising an operation procedure creating unit for setting an access management object apparatus necessary for dealing with a given operation event and creating an operation procedure comprised of a sequence of access management object apparatuses in the order of operation.

3. A maintenance operation-assisting access management apparatus for managing maintenance operations involving a maintenance operation access management object apparatus, the maintenance operation-assisting access management apparatus capable of communicating with an electronic device possessed by a maintenance operator via a network, the maintenance operation-assisting access management apparatus comprising:
an access right establishing unit for establishing the right of access to the maintenance operation access management object apparatus necessary for implementing a given maintenance procedure; and
an access-right managing unit for transmitting the access right established by the access right establishing unit to the electronic device.

4. The maintenance operation-assisting access management apparatus according to claim 3, further comprising:
an access right storage unit for storing knowledge associating maintenance procedures and access rights, wherein
the access right establishing unit establishes the access right based on the maintenance procedure-access right associating knowledge stored in the access right storage unit.

5. The maintenance operation-assisting access management apparatus according to claim 3, wherein the access-right managing unit erases the access right transmitted to the electronic device after the completion of maintenance operation.

6. The maintenance operation-assisting access management apparatus according to claim 3, further comprising a maintenance procedure creating unit for setting a maintenance operation access management object apparatus necessary for dealing with a given maintenance operation event and creating a maintenance procedure comprised of a sequence of maintenance operation access management object apparatuses in the order of maintenance operation.

7. The maintenance operation-assisting access management apparatus according to claim 6, further comprising a maintenance procedure storage unit for storing knowledge associating maintenance operation events and maintenance procedures, wherein
the maintenance procedure creating unit creates a maintenance procedure based on the maintenance operation event-maintenance procedure associating knowledge stored in the maintenance procedure storage unit.

8. The maintenance operation-assisting access management apparatus according to claim 3, which is capable of communicating with a maintenance operation access management object apparatus via a network, wherein
the access right establishing unit establishes a temporary access right for accessing the maintenance operation access management object apparatus temporarily, wherein the temporary access right is transmitted by the access-right managing unit to the access management object apparatus and the electronic device and is erased after operation.

9. The maintenance operation-assisting access management apparatus according to any one of claims 3, wherein the maintenance procedure includes a conduct procedure in order for the maintenance operator to arrive at the maintenance operation access management object apparatus.

10. The maintenance operation-assisting access management apparatus according to claim 3, wherein the maintenance procedure includes an operation procedure the operator is obligated to perform based on a contract.

11. An access management object apparatus that requires an access right for operation, wherein the apparatus can be accessed using the access right transmitted from the access management apparatus according to claim 1.

12. A maintenance operation access management object apparatus that requires an access right for operation, wherein the apparatus can be accessed using the access right transmitted from the maintenance operation-assisting access management apparatus according to claim 3.

13. A maintenance operation bidding method for determining an operator of a given maintenance operation based on a bidding participated by a plurality of maintenance operators, wherein the maintenance operation is carried out using the maintenance operation-assisting access management apparatus according to claim 3, wherein the access right according to claim 3 is given to the selected maintenance operator.

14. The maintenance operation bidding method according to claim 13, wherein the maintenance procedure is disclosed to the multiple maintenance operators.

15. The maintenance operation bidding method according to claim 13, wherein the maintenance operators participating in the bidding are charged a participation fee.

16. An access management method for managing an operation involving an access management object apparatus by communicating with an electronic device possessed by an operator via a network, the method comprising:
an access right establishing step of establishing the right of access to the access management object apparatus necessary for implementing a given operation procedure; and
an access-right managing step of transmitting the access right established in the access right establishing step to the electronic device.

17. The access management method according to claim 16, further comprising an operation procedure creating step of setting an access management object apparatus necessary for dealing with a given operation event and creating an operation procedure comprised of a sequence of access management object apparatuses in the order of operation.

18. A maintenance operation-assisting access management method for managing a maintenance operation involving a maintenance operation access management object apparatus by communicating with an electronic device possessed by a maintenance operator via a network, the method comprising:
an access right establishing step of establishing the right of access to the maintenance operation access management object apparatus necessary for implementing a given maintenance procedure; and
an access-right managing step of transmitting the access right established in the access right establishing step to the electronic device.

19. The maintenance operation-assisting access management method according to claim 18, wherein in the access right establishing step, the access right is established based on knowledge associating maintenance procedures and access rights.

20. The maintenance operation-assisting access management method according to claim 18, further comprising an access-right managing step of erasing the access right transmitted to the electronic device after the completion of the maintenance operation.

21. The maintenance operation-assisting access management method according to claim 18, further comprising a maintenance procedure creating step of setting an access management object apparatus necessary for dealing with a given maintenance operation event and creating a maintenance procedure comprised of a sequence of access management object apparatuses in the order of maintenance operation.

22. The maintenance operation-assisting access management method according to claim 21, wherein in the maintenance procedure creating step, the maintenance procedure is created based on knowledge associating maintenance operation events and maintenance procedures.

23. The maintenance operation-assisting access management method according to claim 18, which is carried out by communicating with the maintenance operation access management object apparatus via a network, wherein in the access right establishing step, a temporary access right is established for temporary access to the maintenance operation access management object apparatus, and in the access-right managing step, the temporary access right is transmitted to the maintenance operation access management object apparatus and the electronic device, the temporary access right being erased after the completion of the operation.

24. The maintenance operation-assisting access management method according to claim 18, wherein the maintenance procedure includes a conduct procedure to be followed by the maintenance operator before arriving at the access management object apparatus.

25. The maintenance operation-assisting access management method according to claim 18, wherein the maintenance procedure includes an operation procedure the operator is obligated to perform based on a contract.

26. An access managing program for accessing an access management object apparatus, the program allowing a computer to realize the access managing method according to claim 16.

27. An access managing program for accessing an access management object apparatus for assisting maintenance operation, the program allowing a computer to realize the maintenance operation-assisting access management method according to claim 18.

28. A computer-readable recording medium on which the access management program according to claim 26 is recorded.
